(19) United States
(12) Patent Application Publication
(10) Pub. No.: US 2023/0177616 A1
(43) Pub. Date: Jun. 8, 2023

(54) SYSTEM AND COMPUTER-IMPLEMENTED METHOD FOR USING IMAGES TO EVALUATE PROPERTY DAMAGE CLAIMS AND PERFORM RELATED ACTIONS

(71) Applicant: State Farm Mutual Automobile Insurance Company, Bloomington, IL (US)

(72) Inventors: David Thurber, Sherman, IL (US); Paul Rutkowski, Normal, IL (US); Michael Aviles, Bloomington, IL (US); Ivan Hall, Bloomington, IL (US); George T. Dulee, JR., Bloomington, IL (US); Michael Bernico, Bloomington, IL (US); Timothy J. Nickel, Bloomington, IL (US); Joshua Samara, Bloomington, IL (US); William J. Leise, Normal, IL (US)

(73) Assignee: State Farm Mutual Automobile Insurance Company, Bloomington, IL (US)

(21) Appl. No.: 18/101,651

(22) Filed: Jan. 26, 2023

Related U.S. Application Data
(63) Continuation of application No. 15/348,479, filed on Nov. 10, 2016.
(60) Provisional application No. 62/256,415, filed on Nov. 17, 2015.

(51) Int. Cl. G06Q 40/08; G06N 20/00; G06Q 30/0283

(52) U.S. Cl. CPC G06Q 40/08; G06N 20/00; G06Q 30/0283; G06Q 10/20

(57) ABSTRACT

A system and method for processing an insurance claim for damage to a vehicle, home, or other property. Image data of the damaged property may be examined, with an insured's permission or affirmative consent, by a processor using a machine learning technology to determine the amount of damage; determine a repair or replacement cost; generate a proposed insurance claim and initiate processing the insurance claim; and perform additional actions relevant to handling the insurance claim or assisting the claimant. The additional actions may include estimating a repair or replacement cost and time; identifying a repair service; determining an availability of repair parts and appointments; identifying one or more salvage services; identifying settlement options; and identifying temporary replacement property (e.g., rental vehicles or hotel rooms). The processor may receive and account for GPS location of the damaged property or the insured's mobile device, and/or the forecasted weather for that location.

### RELATED APPLICATIONS

The present U.S. non-provisional patent application is related to and claims priority benefit of an earlier-filed provisional patent application having the same title, Ser. No. 62/256,415, filed Nov. 17, 2015. The entire content of the identified earlier-filed application is hereby incorporated by reference into the present application as if fully set forth herein.

### FIELD OF THE DISCLOSURE

The present disclosure generally relates to systems and methods for facilitating insurance claims for damages to properties. More particularly, the present disclosure relates to systems and computer-implemented methods for analyzing still and/or moving (i.e., video) images and/or audio recordings of damaged properties to assess the damage, processing associated property insurance claims, and performing additional actions related to the claims and/or otherwise relevant to the claimants.

### BACKGROUND

Property insurance, such as vehicle insurance and homeowner insurance, exists to provide financial protection against physical damage and/or bodily injury resulting from loss events and against liability that could arise therefrom. Typically, a customer may purchase a property insurance policy for a policy rate having a specified term. In exchange for payments from the insured customer, the insurer pays for damages to the insured which are caused by covered perils, acts, or events as specified by the language of the insurance policy. The payments from the insured are generally referred to as “premiums,” and may be paid on behalf of the insured over time at periodic intervals.

In the event of damage to the property or injury to a person associated with the property, which may be referred to as a “loss event,” the customer may identify and contact a repairer in order to obtain a professional estimate of the amount of damage to the property, and often must make other relevant arrangements, such as identifying and contacting providers of rental or otherwise temporary replacement property. Because of these and other issues, making and processing the insurance claim and performing other related actions may sometimes be inefficient and inconvenient for the claimant.

### BRIEF SUMMARY

Embodiments of the present technology relate to systems and computer-implemented methods for analyzing still and/or moving (i.e., video) images and/or audio recordings of a damaged property to assess the damage, processing an associated property insurance claim, and performing one or more additional actions related to the claim and/or otherwise relevant to the claimant.

In a first aspect, a system for processing an insurance claim by a claimant for damage to a property, wherein the property is a vehicle or a structure, may broadly comprise a memory and a processor. The memory may be configured to store a set of image models generated according to a machine learning technique. The processor may be configured to receive image data depicting the damaged property; may identify at least one characteristic of the image data; may access an image model of the set of image models in the memory, the image model corresponding to the at least one characteristic of the image data; and/or may analyze the image data according to the image model to determine an amount of damage to the property as indicated in the image data. The processor may access an insurance policy associated with the property, and may initiate a processing of the insurance claim. The processor may perform one or more additional actions related to processing the insurance claim or otherwise relevant to the claimant.

In a second aspect, a computer-implemented method for improving the functionality of a computer for processing an insurance claim by a claimant for damage to a property may broadly comprise the following. A set of image models generated according to a machine learning technique may be stored in a memory. Image data depicting the damaged property may be received at a processor. At least one characteristic of the image data may be identified by the processor. An image model of the set of image models corresponding to the at least one characteristic of the image data may be accessed from the memory. The image data may be analyzed by the processor according to the image model to determine an amount of damage to the property as indicated in the image data. An insurance policy associated with the property may be accessed by the processor, and processing of the insurance claim may be initiated by the processor. One or more additional actions related to processing the insurance claim or otherwise relevant to the claimant may be performed by the processor.

In a third aspect, a non-transitory computer-readable medium with an executable program stored thereon for improving the functionality of a computer for processing an insurance claim by a claimant for damage to a property may broadly instruct a system including a memory and a processor to perform the following actions. The memory may be instructed to store a set of image models each generated according to a machine learning technique. The processor may be instructed to receive image data depicting the damaged property; may identify at least one characteristic of the image data; may be instructed to access an image model of the set of image models in the memory, the image model corresponding to the at least one characteristic of the image data; and/or may be instructed to analyze the image data according to the image model to determine an amount of damage to the property as indicated in the image data. The processor may be instructed to access an insurance policy associated with the property, and may be instructed to initiate processing of the insurance claim. The processor may be instructed to perform one or more additional actions related to processing the insurance claim or otherwise relevant to the claimant.

Various implementations of any or all of the foregoing aspects may include any one or more of the following additional features. The property may be a vehicle or a structure. The image data may consist of a single image of the vehicle (or structure, such as a home), or the image data may include one or more still images or moving images of the vehicle (or structure). The one or more additional relevant actions may be performed substantially automatically and without human interaction. The one or more additional actions may include (1) estimating an amount of damage to the property; (2) estimating a cost of repairing the damage to the property (or replacing various damaged items); (3) estimating a repair time for repairing the damage to the property (or replacement time or replace various damaged items); (4) identifying one or more repair services capable of repairing the damage to the property; (5) determining an availability of repair parts and an availability of repair appointments; (6) identifying one or more salvage services capable of salvaging the damaged property; (7) identifying one or more settlement options for settling the insurance claim; and/or (8) identifying a temporary replacement property for the damaged property. The processor may receive geographic location data for the damaged property or the claimant, and may consider the geographic location data when performing the one or more additional actions. Additionally or alternatively, the processor may use the geographic location data to determine a forecasted weather for the geographic location, and may consider the forecasted weather when performing the additional actions. The processor may further receive and analyze audio data according to an audio model in the same manner as the image data.

Advantages of these and other embodiments will become more apparent to those skilled in the art from the following description of the exemplary embodiments which have been shown and described by way of illustration. As will be realized, the present embodiments described herein may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals. The present embodiments are not limited to the precise arrangements and instrumentalities shown in the Figures.

FIG. 1 is an exemplary representation of generating image models, in accordance with some embodiments of the present technology;

FIG. 2 depicts an exemplary environment including components and entities associated with processing image data according to image models to assess property damage, in accordance with some embodiments;

FIG. 3 is a hardware diagram of an exemplary processing server, in accordance with some embodiments;

FIG. 4 is a block diagram of an exemplary method of analyzing image data to determine or identify property damage and initiate processing an insurance policy, in accordance with some embodiments;

FIG. 5 is a block diagram of an exemplary method of performing one or more additional actions related to processing the insurance claim or otherwise relevant to the claimant, in accordance with some embodiments; and

FIG. 6 depicts an exemplary vehicle (or home) damage classification training flow.

The Figures depict exemplary embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, systems and methods for analyzing still and/or moving (i.e., video) images and/or audio recordings of damaged properties to assess the damage, processing associated property insurance claims, and performing additional actions related to the claims and/or otherwise relevant to the claimants. The types of properties may include fixed and/or mobile properties, dwellings and/or vehicles, such as residential homes, commercial buildings, and/or or other such buildings or structures, and/or cars, trucks, motorcycles, snowmobiles, boats or other watercraft, airplanes, and/or other such land, water, or air vehicles, whether privately or commercially owned. Further, each of the properties may be the subject of an associated property insurance policy that provides financial protection against physical damage and/or bodily injury resulting from loss events and against liability associated with the property.

According to embodiments, various components and devices may be configured to capture image data of or otherwise associated with the property. In particular, the various components and devices may include imaging devices and may be manually, automatically, and/or remotely controlled or monitored, whereby the imaging devices may be implemented in various devices such as digital cameras, smart phones, unmanned aerial vehicles (UAVs), satellites, and/or the like. The components and devices may transmit the captured image data to a remote server, such as a server associated with an insurance provider or another entity.

The remote server may be configured to generate and/or access an image model that the remote server may use to analyze the received image data. To generate an image model, an image processing server may implement one or more machine learning techniques, or “deep learning” techniques, to model high level abstractions in image data by using architectures composed of multiple non-linear transformations. Generally, “deep learning” is a term used to describe various machine learning methods (e.g., deep neural networks, convolutional deep neural networks, deep belief networks, etc.) that are based upon learning representations. In operation, an observation such as an image may be represented in a variety of ways or patterns corresponding to different levels of composition or abstraction, whereby some representations enable easier learning of certain tasks of interest from examples. As different concepts are learned from other concepts, the deep learning techniques improve these representations and create models that learn the representations. In some cases, a deep neural network with at least one hidden layer of units between input and output layers may be used to generate an image model. In other cases, a convolutional neural network composed of one or more convolutional layers with fully connected layers on top, as well as weights and pooling layers, may be used to generate the image model. Further, the image model may be organized into various classifications and labels corresponding to the types of properties and the depicted portions of the properties.

By analyzing received image and/or audio data according to an appropriate model, the remote server may facilitate various calculations and estimations relevant to property damage claims. In particular, the remote server may calculate or estimate an amount of damage to the associated property; a repair cost of the damage; any bodily injuries; and/or other information. Further, the remote server may facilitate various applications and functionalities related to processing insurance claims associated with the properties. In particular, the remote server may initiate certain resources to handle or mitigate property damage, notify policyholders of damage amounts; pre-fill insurance claim forms based upon the calculated damage and other metrics; and/or facilitate similar applications and functionalities.

Further, the remote server may perform one or more additional actions related to processing the insurance claim and/or relevant to the claimant, such as estimating a repair time for repairing the damage to the property; identifying one or more repair services capable of repairing the damage to the property; determining an availability of repair parts and an availability of repair appointments (such as appointments at auto bodies); identifying one or more salvage services capable of salvaging the damaged property; identifying one or more settlement options for settling the insurance claim; and/or identifying a temporary replacement property for the damaged property. Additionally, the remote server may receive geographic location data for the damaged property or the claimant, and may consider the geographic location data when performing the one or more additional actions, such as determining available services closest to the location of a damaged vehicle or home. Relatedly, remote server may use the geographic location data to determine a forecasted weather for the geographic location, and may consider the forecasted weather when performing the one or more additional actions. Some or all of these actions performed by the remote server may be performed substantially automatically and without human intervention.

The systems and methods may therefore offer numerous benefits. In particular, analyzing received image data according to the image model may provide for accurate assessments of degrees of damage to the properties. Further, by automatically estimating and calculating property damage data, the amount of resources needed by insurance providers to initiate insurance claim processing may be reduced. Additionally, customers having property insurance policies may be afforded the benefit of an efficient and accurate damage assessment to their properties. Moreover, by initiating and automating at least a portion of the claim filing process, customers may be afforded reduced claim filing times with a reduced amount of effort and inconvenience. Additionally, by performing additional actions related to processing the insurance claim and/or relevant to the claimant, the process and experience may be made more efficient and convenient and, in general, improved.

The content of currently pending U.S. non-provisional patent application titled “Systems and Methods for Analyzing Image Data to Assess Property Damage,” Ser. No. 14/666,889, filed Mar. 24, 2015, is hereby incorporated by reference into the present specification as if set forth herein in its entirety.

### Exemplary System

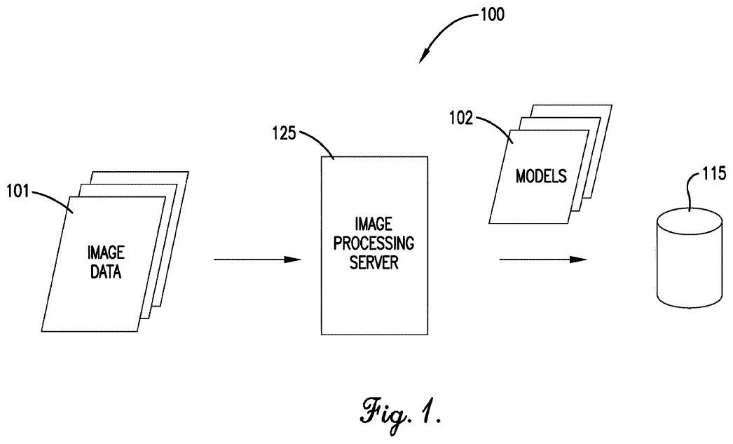

Referring to FIG. 1, an exemplary system 100 is shown for creating or generating various image models, and broadly including image data 101, an image processing server 125, and a database 115. Although described for exemplary purposes as receiving and handling image data, the system 100 may be configured to alternatively or additionally similarly receive and handle audio data.

Generally, the image processing server 125 may receive or otherwise access the image data 101 from a variety of sources, such as various storage devices or image capture devices. The images of the image data 101 may or may not be related to each other. For example, the images may be a series of images of vehicles (e.g., cars, trucks, motorcycles, boats, etc.). For further example, the images may be a series of images of structures (e.g., residential homes, commercial buildings, etc.). It should be appreciated that the image data 101 may depict other properties, components, or objects. The images of the image data 101 may include different portions or sections of depicted objects. For example, if the images depict vehicles, the images may include front views, side views, top views, back views, exterior images, interior images, images of wheels, images of bumpers, images of windows, and/or other views or images of other components or sections. For further example, if the images depict structures, the images may similarly include front views, side views, top views, back views, exterior images, interior images, images of specific rooms such as kitchens, living rooms, bedrooms, bathrooms, and the like, images of specific components such as furniture, furnaces, hot water heaters, building components, and/or other views or images of other components or sections.

The image processing server 125 may use the image data 101 to generate one or more image models 102. Generally, the image processing server 125 may employ various deep learning techniques to generate the image model(s) 102, as discussed herein. It should be appreciated that the image processing server 125 may use additional algorithms or techniques to generate the image models 102. In particular, the image processing server 125 may employ autoencoders; multilayer perceptron (MLP) models; various other neural networks including recurrent neural networks (RNN), restricted Boltzmann machines (RBM), self-organizing maps (SOM) or self-organizing feature maps (SOFM), or convolutional neural networks (CNN); and/or other types of models, techniques, algorithms, calculations, or the like. The image processing server 125 may employ neural networks that are trained for generic image recognition on specific tasks, which may be in addition to performing the deep learning techniques. Accordingly, the image processing server 125 may evaluate whether features extracted from a deep network on a set of object recognition tasks may be re-purposed to other tasks.

Generally, the image model(s) 102 may organize and/or identify various features or characteristics of the image data 101 (such as those features or characteristics identified above). In some implementations, a user may interface with the image processing server 125 to provide input that the image processing server 125 may use to generate the image models 102. In particular, the user may specify or name certain features or characteristics that may be common to a portion(s) of the image data 101, which the image processing server 125 may use to classify the image data 101. Accordingly, the image data 101 may be a set of one or more images from which a user may want to generate the image models 102.

After generating the image models 102, the image processing server 125 may be configured to store the image models 102 in the database 115. Further, the image processing server 125 may access any of the image models 102 from the database 115 for applying to any additional image data, as well as for updating any of the image models 102. The database 115 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The image processing server 125 may be associated with an insurance provider. Accordingly, the image data 101 may include images that are contained in past insurance claim filings, such as insurance claim filings associated with vehicle damage. The image processing server 125 may further reference or access various claims processing data such as costs, repair time, data regarding point(s) of impact, specific subsystems costs (e.g., frame costs, paint costs, and parts costs). This data may be compiled into a historical claims filing database.

In operation, the image processing server 125 may generate the image models 102 using data from the historical claims filing database or dataset (e.g., a file store or a federated data warehouse). Accordingly, the image processing server 125 may use the image models 102 to predict various insurance claim filing parameters such as costs, parts, and repair hours. In analyzing the image models 102, the image processing server 125 may examine one or more customer-supplied images as well as any selections associated with vehicle damage (e.g., point of impact).

One or more users may interface with the image processing server 125 to identify a set of images that best represents the customer selections, at which point the claim may be considered labeled. After the claim is labeled, the image processing server 125 may analyze the set of customer-supplied images according to a neural network that is pre-trained on the dataset images. The image processing server 125 may then extract various visual features that the neural network discovers as an array of N (e.g., 4,096 or other amounts) floating point numbers from the first fully-connected layer of the neural network. The image processing server 125 may combine the N visual features with structured data (e.g., cost information, repair time information, point of impact) into an M×N matrix (“X” matrix) where each row M may be a single claim experience and each column N may be a known variable about the claim.

The image processing server 125 may make a set of predictions, each for a different dependent variable “y.” The set of predictions may correspond to, for example, a cost, a number of hours to repair, an amount to repair or replace items, and others. Based upon the prediction, the corresponding variable may be removed from the “X” matrix and assigned to “y.”

The image processing server 125 may also send the relevant portion of the “X” matrix (e.g., the visual features, the point of impact) along with “y” to a set of machine learning algorithms. In some embodiments, the set of machine learning algorithms may include random forests, gradient boosted trees, support vector machines, and/or others. Using the data from the historical claims filing database in conjunction with the chosen dependent variable, the set of machine learning algorithms may learn to make predictions based upon future claims images. Although each of these predictors may result in a different prediction, the image processing server 125 may use the “average” prediction as an estimate value.

The image processing server 125 may further support an out of sample validation strategy for the set of machine learning algorithms where a portion of the “X” matrix and “y” may be excluded from the test set. The data may then be split into training and cross-validation, where the model may be trained on the training data and the cross-validation may be used to assess the goodness of fit. The image processing server 125 may repeat this functionality a number of times until the model's error has stabilized and optimal hyper parameters (i.e., parameters for the respective models) have been chosen, which is known as k-fold cross validation. The image processing server 125 may serialize the final set of machine learning algorithms and avail the final set into a production flow of images.

Accordingly, if a customer (e.g., a policyholder) experiences a loss event and has a resulting insurance claim filing, then the customer may submit the insurance claim along with any images and supplemental information to the image processing server 125. The image processing server 125 may analyze the received image and supplemental information according to the image models 102 and calculate a predicted damage value. In some embodiments, if the predicted damage value is below a threshold specified by the insurance provider (e.g., 10 hours to repair), then the insurance provider may pay or process the insurance claim without further adjustment, review, or processing. Additionally, the insurance provider may account for a degree of certainty for the predictor results. For example, the insurance provider may pay or process an insurance claim if the image processing server 125 determines that it is 80% certain that a calculated repair time is under 10 hours. It should be appreciated that different threshold values and degrees of certainty are envisioned.

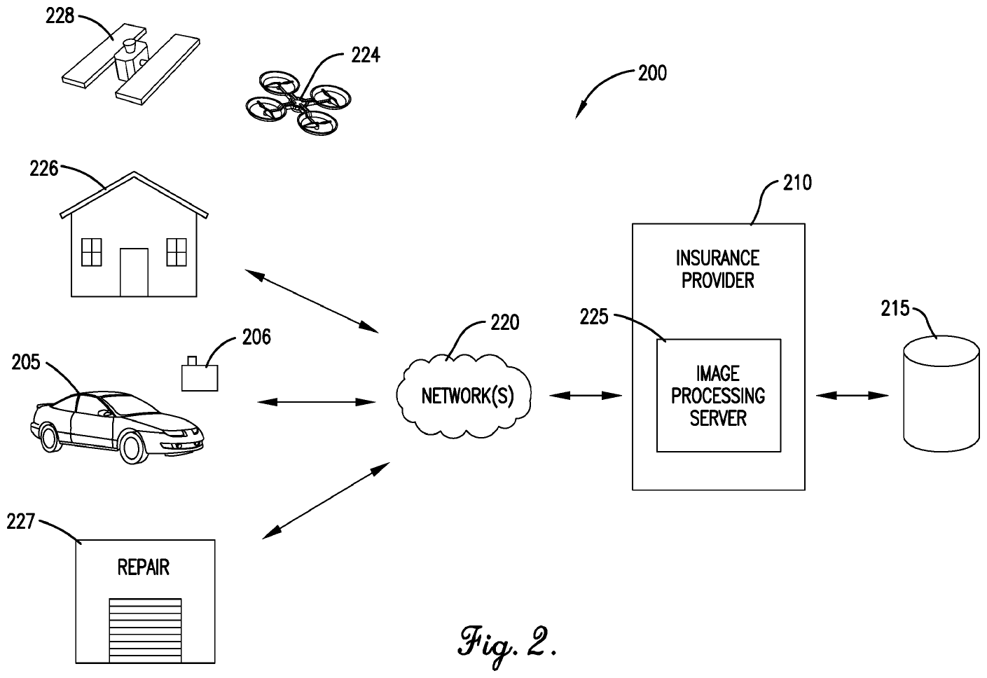

FIG. 2 depicts an exemplary environment 200 associated with capturing image data and analyzing the image data according to various image models. The analyses may be used to assess property damage, process insurance policies, and/or perform other functionalities. Although FIG. 2 depicts certain entities, components, and devices, it should be appreciated that additional or alternate entities and components are envisioned.

The environment 200 depicts certain objects, components, and entities capable of being photographed, such as a vehicle 205 and a structure 226. The vehicle 205 may be any type of car, automobile, truck, motorcycle, fleet of vehicles, marine vessel, or other vehicle capable of being driven or operated by a driver or operator (or, in some cases, operated autonomously by onboard computers). The structure 226 may be any type of building such as a residential home, a trailer, a commercial building, or other type of physical structure.

Each of the vehicle 205 and/or the structure 226 may have an associated insurance policy through an insurance provider 210. The insurance policy may cover or insure damage to the vehicle 205 and/or the structure 226, and/or liability that may result from loss events associated with the vehicle 205 and/or the structure 226. In some cases, the vehicle 205 and/or the structure 226 may not be covered by an insurance policy but may be eligible to be covered by an insurance policy. The insurance provider 210 may be substantially any individual, group of individuals, company, corporation, or other type of entity that may offer and issue insurance policies for customers, such as a vehicle insurance policy for the vehicle 205 or a property insurance policy for the structure 226.

Each of the vehicle 205 and the structure 226 are capable of being photographed by one or more imaging devices 206. Generally, the imaging device 206 may be any component or device with an image sensor capable of capturing optical data and converting the optical data into digital image data. In some implementations, the imaging device 206 may be an analog camera capable of capturing analog images that may be converted into electronic data. The imaging device 206 may be embodied in many forms, including a dedicated camera, smartphone, notebook computer, tablet, PDA, and/or the like. The environment 200 further includes an unmanned aerial vehicle (UAV) or “drone” 224 that may be equipped with an imaging device (such as a camera) that is capable of capturing images of various portions of the structure 226. Generally, the UAV 224 may be any unmanned aircraft having its flight controlled either autonomously by onboard computers or by the remote control of a pilot on the ground or in a vehicle.

Although FIG. 2 depicts a single vehicle 205 and a single structure 226, it should be appreciated that multiple vehicles and/or multiple structures may be incorporated into the embodiments discussed herein. For example, image data may be captured of multiple vehicles in a parking lot. For further example, image data may be captured of multiple homes in a neighborhood.

The imaging device 206 and the UAV 224 may be operated automatically or manually, and with or without human intervention. Further, the imaging device 206 and the UAV 224 may capture one or more images at one or more separate times. In some embodiments, one or more satellites 228 may be configured to capture images of the structure 226 and/or the vehicle 205, as well as one or more additional structures or vehicles in proximity to the structure 226 or the vehicle 205. It should be appreciated that components capable of image capture other than the imaging device 206, the UAV 224, and the satellite 228 are envisioned.

The imaging device 206, the UAV 224, and the satellite 228 may be configured to communicate with the insurance provider 210 via a network 220. In some implementations, the imaging device 206, the UAV 224, and the satellite 228 may communicate with another server that is accessible by the insurance provider 210 via the network(s) 220. The network 220 may facilitate substantially any type of data communication via any standard or technology (e.g., GSM, CDMA, TDMA, WCDMA, LTE, EDGE, OFDM, GPRS, EV-DO, UWB, WiFi, IEEE 802 including Ethernet, WiMAX, and/or others). The network 220 may also support various local area networks (LAN), personal area networks (PAN), or short range communication protocols.

The insurance provider 210 may include an image processing server 225, such as the image processing server 125 discussed with respect to FIG. 1. Although FIG. 2 depicts the image processing server 225 as a part of the insurance provider 210, it should be appreciated that the image processing server 225 may be separate from (and connected to or accessible by) the insurance provider 210. The image processing server 225 may be coupled to a database 215, such as the database 115 discussed with respect to FIG. 1, configured to store various data associated with vehicle insurance policies. Additionally, the database 215 may store any image data received from the imaging device 206, the UAV 224, and/or the satellite 228. Further, the database 215 may store data associated with image models that may be generated by the image processing server 225.

The imaging device 206, the UAV 224, and the satellite 228 may be configured to communicate or transmit image data (i.e., captured images) of the vehicle 205 and/or structure 226 to the image processing server 225 via the network 220. In some implementations, the image processing server 225 may access or retrieve the image data from other sources. The image processing server 225 may be configured to access an image model (e.g., from the database 215) that corresponds to the received image data, and/or to one or more characteristics of the received image data. In particular, the image processing server 225 may examine the received image data to identify certain objects/components depicted therein and characteristics associated therewith. For example, if the received image data depicts the vehicle 205, the image processing server 225 may retrieve an image model including data that is relevant to identifying vehicle damage. For further example, if the image data depicts a residential home, the image processing server 225 may retrieve an additional image model that is relevant to identifying structure damage.

The system 200 may be implemented for various uses or applications, such as various uses or applications related to processing or managing insurance claims and/or insurance policies. In particular, the image processing server 225 may create and/or access various image models to process various images according to the particular use or application. The image processing server 225 may perform these analyses and techniques automatically upon receipt of image data or upon detection of a loss event. The image processing server 252 therefore may reduce the amount of time associated with filing insurance claims and/or processing insurance claims.

The image processing server 225 may analyze images of vehicles to classify degrees of damage. In particular, the image processing server 225 may receive image data of one or more vehicles, and analyze the image data of the one or more vehicles according to a certain image model to classify an appropriate damage class for the one or more vehicles, which may be a qualitative or quantitative measure. For example, the image processing server 225 may examine images from the imaging device 206 to determine that the vehicle 205 has a light (or medium, heavy, totaled, etc.) amount of damage. The insurance provider 210 may further use the classifications to process insurance claims that may result from any damaged vehicles.

Alternatively or additionally, the image processing server 225 may analyze images of vehicles to automatically estimate a cost of repair for certain damage to certain vehicles. In particular, the image processing server 225 may process image data of the vehicle 205 according to an appropriate image model to identify specific damage to the vehicle 205, and may further estimate or approximate a cost to repair the damage (or replace damaged items or parts) based upon known damage repair data. Further, the image processing server 225 may estimate a repair or replacement time for the identified damage to the vehicle 205, based upon existing repair or replacement time data for certain damage. Still further, the image processing server 225 may use the identified damage to the vehicle 205 to estimate passenger injury. In particular, the image processing server 225 may estimate the likely harm to one or more occupants of the vehicle 205 based upon the severity of the identified damage, the location of the damage, the make, model, and year of the vehicle, and/or other data. As illustrated in FIG. 2, the image processing server 225 may interface with a repair or “body” shop 227 to retrieve relevant data, determine estimates, submit work orders, schedule appointments, or the like. The image processing server 225 may further identify at least one part that may be needed to repair (or replace) any damage to the vehicle 205.

Additionally or alternatively, the image processing server 225 may identify various parts or supplies needed to repair the identified damage to the vehicle (or replace damaged items or parts) 205. In particular, the image processing server 225 may identify, from the image data according to a proper image model, the make, model, and/or year of the vehicle 205, as well as identify areas of damage to the vehicle 205 and a listing of parts or supplies needed to repair the areas of damage to the identified vehicle 205. The image processing server 225 may also interface with the repair shop 227 to order the identified parts for repairing the vehicle 205. It should be appreciated that the image processing server 225 may interface with additional local or third-party entities, components, or the like to access or retrieve data that may be relevant for facilitating these described functionalities, determinations, and calculations.

In one embodiment, after initiating processing of the insurance claim, the image processing server 225, or, more specifically, processor 322 and memory 378 components of the server 225, may perform one or more additional actions related to processing the insurance claim and/or otherwise relevant to the claimant. For example, the server 225 may estimate a repair time for repairing the damage to the property, may identify one or more repair services capable of repairing the damage to the property, and/or may determine an availability of repair parts and an availability of repair appointments, and communicate this information to the claimant or other appropriate person for consideration. If appropriate given the damage to the property, the server 225 may identify one or more salvage services capable of salvaging the damaged property, and communicate that information to the claimant or other appropriate person. The server 225 may identify one or more settlement options for settling the insurance claim, and communicate that information to the claimant or other appropriate person. The server 225 may identify a temporary rental or other replacement property for the damaged property, and communicate that information to the claimant or other appropriate person. One or more of these additional actions may be performed substantially automatically and without human interaction.

Further, the server 225 may be configured to receive or otherwise determine geographic location data for the damaged property or the claimant, and to consider the geographic location data when performing the one or more additional relevant actions. For example, the geographic location of the damaged property may be useful in identifying appropriate repair facilities, and the geographic location of the claimant may be useful in identifying appropriate temporary replacement property. Even further, the server 225 may use the geographic location data to or otherwise determine the forecasted weather for the geographic location of the damaged property and/or the claimant, and consider the forecasted weather when performing the one or more additional relevant actions. For example, the weather may influence the decision to identify temporary replacement property, and the kind of replacement property to recommend.

The image processing server 225 may also process image data associated with the structure 226 to facilitate various associated applications and functionalities. In one embodiment, the one or more satellites 228, the UAV 224, and/or the imaging device 206 may capture images of the structure 226 as well as any proximate or surrounding (generally, “additional”) structures to identify damaged structures resulting from a loss event such as a catastrophe or other occurrence (e.g., earthquake, hurricane, tornado, storm, etc.). In some cases, the insurance provider 210 may detect an occurrence of the loss event and, in response, may automatically deploy the UAV 224 and/or the satellite 228 (or other imaging devices) to capture image data in an area surrounding the structure 226. The image processing server 225 may perform the same image model analyses on image data of the additional structures to classify amount(s) of damage to the additional structure(s).

The image processing server 225 may also identify policyholders and relevant policy details associated with any structures that are identified as being damaged. Further, the image processing server 225 may identify specific details on the levels of damage for particular structures, as well as estimate the costs to repair or replace the damage. In particular, the image processing server 225 may generate a “heat map” that visualizes certain areas having certain degrees of damage (e.g., light, medium, heavy, etc.). The image processing server 225 may additionally use the data to prioritize catastrophe or storm response teams or resources. In particular, the image processing server 225 may identify proper staffing levels, triage support, software and hardware needs, as well as levels of other resources that may be used to process insurance policy and claim filings resulting from the structure damage.

The image processing server 225 may analyze updated images of the structure 226 and compare the updated images to stored images of the structure 226 to identify any additions, expansions, or other structural changes to the structure 226. The image processing server 225 may then create a list of structures that have structural changes or additions, where the insurance provider 210 may use the list to update or modify any associated insurance policies. The image processing server 225 may analyze images to identify home materials (e.g., siding or roofing materials) used in the construction of the structure 226, which the insurance provider 210 may use to process or modify any associated insurance policies.

In further embodiments, the insurance provider 210 may be configured to deploy the UAV 224 or other imaging devices in an attempt to capture images of various areas of damage to the structure 226. The use of the UAV 224 may be advantageous due to the ability of the UAV 224 to position itself in many locations and capture images of “hard to reach” places or locations that are not easily captured via conventional techniques. The image processing server 225 may then analyze the images from the UAV 224 to identify and classify any areas or damage and perform any of the described applications after the damage is identified and classified. The image processing server 225 may further identify at least one part that may be needed to repair any damage to the structure 226.

The image processing server 225 may also analyze image data of components and entities other than the vehicle 205 and the structure 226. In one implementation, the image processing server 225 may examine scans of various physical or electronic documents to identify any documents that are not completed fully or correctly. The insurance provider 210 may then initiate communication with a relevant policy holder in an attempt to solicit the missing or incorrect information from the document. In another implementation, the image processing server 225 may examine images captured by an imaging device within the vehicle 205 to analyze actions taken by a driver while in the vehicle 205. For example, the image processing server 225 may detect distracting driver behavior in a vehicle. In another implementation, the image processing server 225 may examine image data from security systems (e.g., x-ray security systems and airports or government buildings) to classify dangerous objects identifiable in the images. In some cases, the image processing server 225 may output a view or listing of objects that should be prioritized for security review.

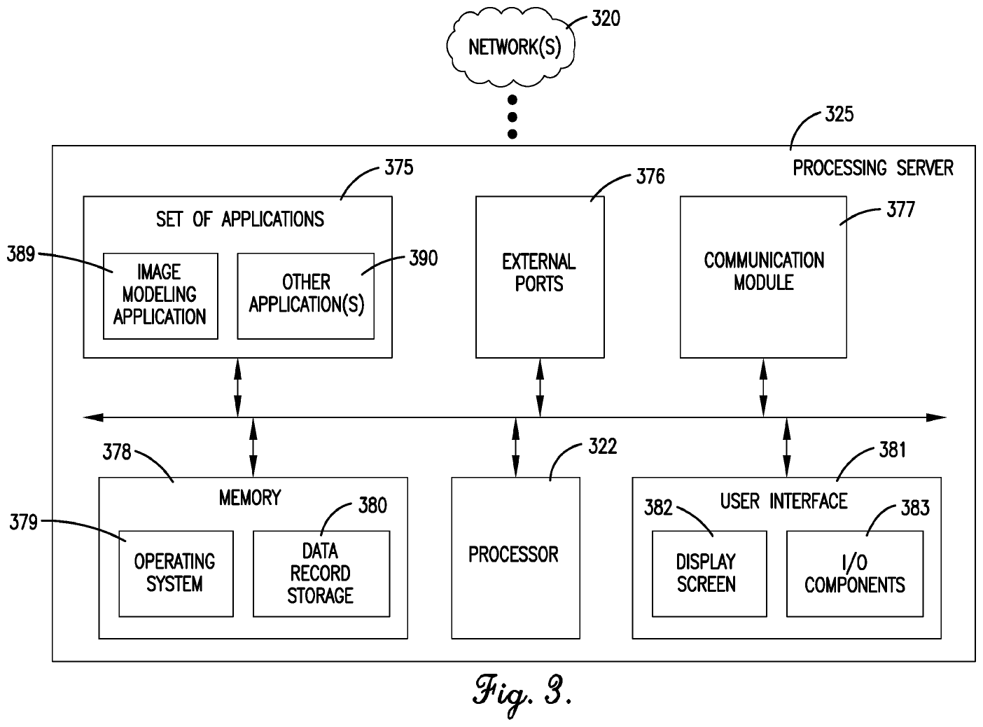

FIG. 3 illustrates a diagram of an exemplary processing server 325 (such as the image processing server 125, 225 discussed with respect to FIGS. 1 and 2) in which the functionalities as discussed herein may be implemented. It should be appreciated that the processing server 325 may be associated with an insurance provider, as discussed herein.

The processing server 325 may include a processor 322 as well as a memory 378. The memory 378 may store an operating system 379 capable of facilitating the functionalities as discussed herein as well as a set of applications 375 (i.e., machine readable instructions). For example, one of the set of applications 375 may be an image modeling application 384 configured to implement one or more deep learning techniques or other algorithms on images to generate one or more image models. It should be appreciated that other applications 390 are envisioned, including an application to analyze additional image data according to any generated image models.

The processor 322 may interface with the memory 378 to execute the operating system 379 and the set of applications 375. According to embodiments, the memory 378 may also include data record storage 380 that includes information related to accounts of customers, including insurance policies and credits associated therewith. The data record storage 380 may also store various image models generated by the image modeling application 384. The memory 378 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The processing server 325 may further include a communication module 377 configured to communicate data via one or more networks 320. According to some embodiments, the communication module 377 may include one or more transceivers (e.g., WWAN, WLAN, and/or WPAN transceivers) functioning in accordance with IEEE standards, 3GPP standards, or other standards, and configured to receive and transmit data via one or more external ports 376. For example, the communication module 377 may receive, via the network 320, images from various image capturing devices or other sources. The processing server 325 may further include a user interface 381 configured to present information to a user and/or receive inputs from the user. The user interface 381 may include a display screen 382 and I/O components 383 (e.g., ports, capacitive or resistive touch sensitive input panels, keys, buttons, lights, LEDs, speakers, microphones). The user may access the processing server 325 via the user interface 381 to assist in generating image models, process insurance policies, and/or perform other functions. The processing server 325 may perform the functionalities as discussed herein as part of a “cloud” network or may otherwise communicate with other hardware or software components within the cloud to send, retrieve, or otherwise analyze data.

The system may include more, fewer, or alternative components and/or perform more, fewer, or alternative actions, including those discussed elsewhere herein, and particularly those discussed in the following section describing the computer-implemented method.

### Exemplary Computer-Implemented Method

Broadly, a computer program product in accordance with an embodiment includes a computer usable storage medium (e.g., standard random access memory (RAM), an optical disc, a universal serial bus (USB) drive, or the like) having computer-readable program code embodied therein, wherein the computer-readable program code is adapted to be executed by the processor 322 (e.g., working in connection with the operating system 379) to facilitate the functions as described herein. In this regard, the program code may be implemented in any desired language, and may be implemented as machine code, assembly code, byte code, interpretable source code or the like (e.g., via C, C++, Java, Actionscript, Objective-C, Javascript, CSS, XML). The computer program product may be part of a cloud network of resources.

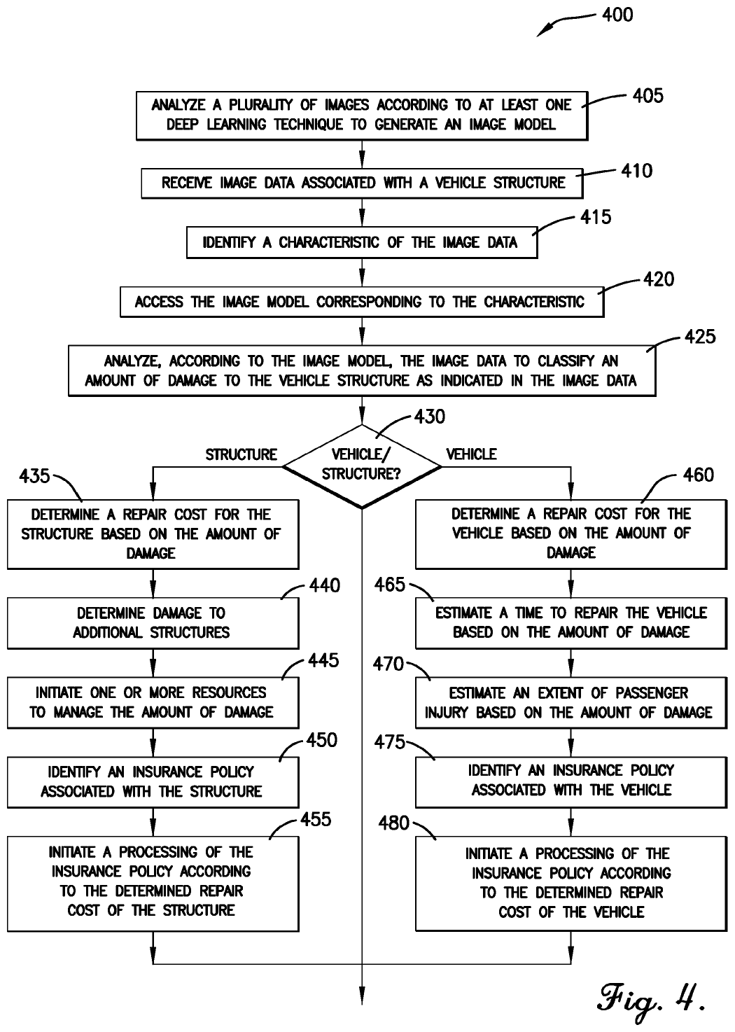

Referring to FIG. 4, an exemplary method 400 for assessing property/structure damage based upon image data and an analysis of an image model is broadly shown comprising the following actions. The method 400 may be facilitated by an image processing server (such as the image processing server 225 discussed with respect to FIG. 2). The image processing server may include at least a processor configured to facilitate the functionalities and a memory configured to store a set of image models.

The image processing server may analyze a plurality of images according to at least one deep learning technique, as shown in 405. As a result of the analysis, the image processing server may generate an image model. The image model may classify various characteristics that are included or indicated in the plurality of images. For example, if the image model is associated with vehicles, the image model may separate front views, rear views, top views, wheel images, interior images, and/or the like. For further example, if the image model is associated with structures, the image model may separate exterior views, interior views, images of doors, images of windows, images of siding or other building materials, images of porches, images of garages, and/or the like. In some implementations, a user may interface with the image processing server to assist in generating the image model, such as by providing input and labels to images.

The image processing server may receive image data associated with the vehicle or structure, as shown in 410. It should be appreciated that the image processing server may receive the image data before, concurrently with, or after generating the image model. Further, the image processing server may receive the image data from various imaging devices associated with the vehicle or structure, such as digital cameras, drone devices, satellites, and/or the like. In some implementations, the image processing server may detect an occurrence of a loss event (e.g., a storm, earthquake, hurricane, etc.) and may automatically initiate an image capture. For example, the image processing server may interface with an insurance provider to deploy UAVs to the area of the loss event, which may include various vehicles and/or structures.

After receiving the image data, the image processing server may identify one or more characteristics of the image data, as shown in 415. The characteristics may correspond to the type of component (e.g., type of vehicle, residential home, commercial building, etc.) identified in the image data, as well as different characteristics associated with the particular type of component (e.g., make/model/year of a vehicle, part/section of a vehicle, section of a property, etc.).

The image processing server may access a portion of the image model corresponding to the characteristic identified in block 415, as shown in 420. In some situations, the entire image model may be too cumbersome for the image processing server to analyze. Instead, the image processing server may access a portion of the image model that corresponds to the received image data, and in particular to the characteristic(s) identified in the received image data. In other situations, the image processing server may access a specific image model of a set of image models that corresponds to the characteristic identified in block 415.

The image processing server may analyze, according to the image model, the image data to classify an amount of damage to the vehicle/structure as indicated in the image data, as shown in 425. In particular, the image processing server may compare the received image data to the classified data in the image model to identify or estimate an amount of damage to the vehicle/structure. The amount of damage may be qualitative in nature. For example, the image processing server may first determine whether the vehicle/structure has incurred damage and, if so, whether the damage is “light,” “medium,” or “heavy.” The image processing server may also identify parts or sections of the vehicle/structure that have incurred damage (e.g., interior, exterior, right side, left side, etc.).

As shown in 430, if the component in the image data is a structure (e.g., home, building, etc.) (“STRUCTURE”), the image processing server may determine or estimate a repair or replacement cost for the structure based upon the amount of damage, as shown in 435. In determining the repair or replacement cost, the image processing server may access local or third-party data that indicates or identifies similar damage and/or amounts of damage to that identified from the received image data. The image processing server may optionally determine or estimate damage to additional structures that may be in proximity to the structure, as shown 440, such as in the case in which the image data is received from satellites or UAVs. In addition to assessing damage to the main or target structure, the image processing server may analyze image data of additional structures according to the image model. The image processing server may also optionally initiate one or more resources to manage the amount of damage, as shown in 445. In particular, the image processing server may interface with an insurance provider to deploy resources (e.g., personnel) to the affected area, notify emergency personnel, initiate various computer hardware and/or software to manage insurance claim processing, or facilitate other actions that may be beneficial to mitigating the damage and/or initiating insurance processing that may result from the damage.

After the amount of damage and the repair cost are estimated or determined, the image processing server may identify or access an insurance policy associated with the structure, as shown in 450. In particular, a policyholder associated with the structure (e.g., an owner or occupant of the structure) may hold the insurance policy, where the insurance policy may insure damage to the structure. The image processing server may also initiate a processing of the insurance policy according to the determined repair cost of the structure, as shown in 455. According to some embodiments, the image processing server may pre-populate one or more insurance claim forms that indicate the amount of damage to the structure and the associated repair cost. The image processing server may also notify a customer(s) (i.e., a policyholder(s)) of the prepopulated insurance claim forms), and may facilitate an insurance claim filing with the customer(s). In additional embodiments, the image processing server may interface with various third parties to initiate an ordering of various parts and supplies to aide in the repair of the structure. It should be appreciated that additional functionalities associated with mitigating or processing the damage to the properties are envisioned.

If the component in the image data is a vehicle (e.g., car, truck, motorcycle, etc.) (“VEHICLE”), the image processing server may determine or estimate a repair or replacement cost for the vehicle based upon the amount of damage, as shown in 460. In determining the repair or replacement cost, the image processing server may access local or third-party data that indicates or identifies similar damage and/or amounts of damage to that identified from the received image data. The image processing server may optionally determine or estimate a time to repair the vehicle (or replace damaged parts) based upon the amount of damage, as shown in 465. Similar to the determination/estimation of block 460, the image processing server may access local or third-party data that indicates or identifies similar repair times for similar amounts of damage to that identified from the received image data. The image processing server may also optionally estimate an extent of passenger injury based upon the amount of damage, as shown in 470, for example using various local or third-party data indicating similar damage.

After the amount of damage and the repair cost are estimated or determined, the image processing server may identify or access an insurance policy associated with the vehicle, as shown in 475. In particular, a policyholder associated with the vehicle (e.g., an owner or operator of the vehicle) may hold the insurance policy, where the insurance policy may insure damage to the vehicle. The image processing server may also initiate a processing of the insurance policy according to the determined repair cost of the vehicle, as shown in 475, and optionally on the estimated extent of passenger injury. According to some embodiments, the image processing server may pre-populate insurance claim forms that indicate the amount of damage to the vehicle and the associated repair cost. The image processing server may also notify a customer(s) (i.e., a policyholder(s)) of the prepopulated insurance claim forms), and may facilitate an insurance claim filing with the customer(s). The image processing server may interface with various third parties to initiate an ordering of various parts and supplies to aide in the repair of the vehicle. It should be appreciated that additional functionalities associated with mitigating or processing the damage to the properties are envisioned.

The image processing server may also initiate a processing of the insurance policy according to the determined repair (or replacement) cost of the vehicle, as shown in 480. According to some embodiments, the image processing server may pre-populate one or more insurance claim forms that indicate the amount of damage to the vehicle and the associated repair cost. The image processing server may also notify a customer(s) (i.e., a policyholder(s)) of the prepopulated insurance claim forms), and may facilitate an insurance claim filing with the customer(s). In additional embodiments, the image processing server may interface with various third parties to initiate an ordering of various parts and supplies to aide in the repair of the vehicle. It should be appreciated that additional functionalities associated with mitigating or processing the damage to the properties are envisioned.

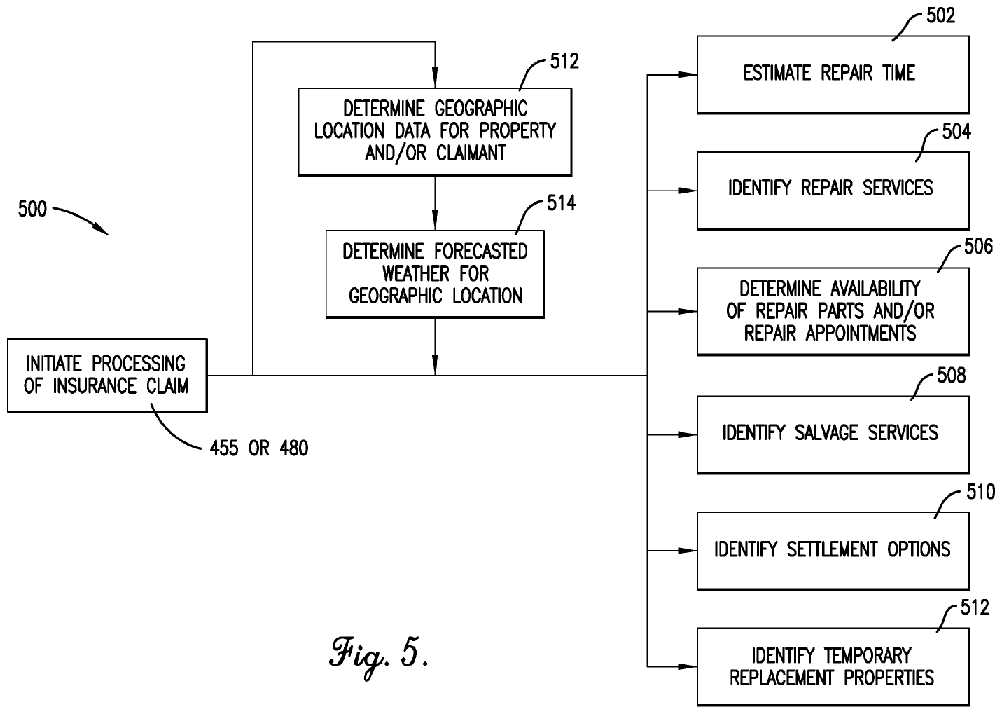

In particular, referring to FIG. 5, an exemplary method 500 for performing one or more additional actions related to processing the insurance claim and/or relevant to the claimant is broadly shown comprising the following actions. The server 225 may estimate a repair time for repairing the damage to the property, as shown in 502, may identify one or more repair services capable of repairing the damage to the property, as shown in 504, and/or may determine an availability of repair parts and an availability of repair appointments, as shown in 506, and communicate this information to the claimant or other appropriate person for consideration. If appropriate given the damage to the property, the server 225 may identify one or more salvage services capable of salvaging the damaged property, as shown in 508, and communicate that information to the claimant or other appropriate person. The server 225 may identify one or more settlement options for settling the insurance claim, as shown in 510, and communicate that information to the claimant or other appropriate person. The server 225 may identify a temporary rental or other replacement property for the damaged property, as shown in 512, and communicate that information to the claimant or other appropriate person. One or more of these additional actions may be performed substantially automatically and without human interaction.

Further, the server 225 may be configured to receive or otherwise determine geographic location data for the damaged property or the claimant, as shown in 512, and to consider the geographic location data when performing the one or more additional actions. For example, the geographic (or GPS (Global Positioning System)) location of the damaged property (such as GPS coordinates determined by a GPS unit of a customer's mobile device that takes images of the damaged property) may be useful in identifying appropriate repair facilities (such as those with a GPS location in close proximity to the GPS location of the damaged property or within a predetermined distance (e.g., 10 miles)), and the geographic (or GPS) location of the claimant may be useful in identifying appropriate temporary replacement property.

Even further, the server 225 may use the geographic (or GPS) location data to or otherwise determine the forecasted weather for the geographic (or GPS) location of the damaged property and/or the claimant, as shown in 514, and consider the forecasted weather when performing the one or more additional actions. For example, the weather may influence the decision to identify temporary replacement property, and the kind of replacement property to recommend.

A first array of images may be used to generate an image model. The first array of images may include exemplary images of vehicles of differing sizes, types, styles, and the like. Further, the first array of images may include different views of the vehicles (e.g., top, side, etc.). According to the embodiments as discussed herein, an image processing server may analyze the images included in the first array of images according to one or more deep learning techniques (or similar techniques or algorithms) to generate an image model. The image model may indicate various characteristics of the images or may otherwise be organized according to certain characteristics or labels included in the images. The image processing server may update the image model with additional images that may be available.

Using the image model generated from the first array of images, the image processing server may analyze any new or additional images for purposes of classifying or performing related functionalities on the new or additional images. A second array of images may be used to analyze and categorize according to the image model. The second array of images may include the same, similar, or different vehicles to those included in the first array of images. The vehicles in the second array of images may have various types and degrees of damage. Accordingly, in analyzing the second array of images, the image processing server may identify or estimate an amount of damage to the respective vehicles. In some implementations, each of the vehicles depicted in the second array of images may be classified as “damaged” with a qualitative amount of damage (e.g., “low,” “medium,” “high,” etc.).

The image processing server may further analyze a third array of images. The third array of images may include the same, similar, or different vehicles to those included in the first and second arrays of images. The vehicles in the third array of images may have various types and degrees of damage. Accordingly, in analyzing the third array of images, the image processing server may identify or estimate an amount of damage to the respective vehicles. In some implementations, each of the vehicles depicted in the third array of images may be classified as “totaled” which may have an associated qualitative amount of damage (e.g., “not repairable”). As the image processing server receives or accesses additional images, the image processing server may analyze the images according to the image model and classify the depicted vehicles according to a determined amount of damage (e.g., the vehicles may be various degrees of “damaged” or “totaled”). The computer-implemented method may include more, fewer, or alternative actions, including those discussed elsewhere herein.

### Exemplary Computer-Readable Medium

Referring again to FIG. 5, an exemplary non-transitory computer-readable medium with an executable program stored thereon for processing an insurance claim by a claimant for damage to a property may broadly instruct the server 225, including the memory 378 and the processor 322, to perform the following actions. The memory 378 may be instructed to store a set of image models each generated according to a machine learning technique. The processor 322 may be instructed to receive image data depicting the damaged property; may identify at least one characteristic of the image data; may be instructed to access an image model of the set of image models in the memory, the image model corresponding to the at least one characteristic of the image data; and/or may be instructed to analyze the image data according to the image model to determine an amount of damage to the property as indicated in the image data. The processor 322 may be instructed to determine a repair or replacement cost for the property based upon the amount of damage to the property; may be instructed to access an insurance policy associated with the property; and may be instructed to initiate a processing of the insurance claim. The processor 322 may be instructed to perform one or more additional actions relevant to processing the insurance claim or otherwise assisting the claimant.

In particular, referring again to FIG. 5, the executable program may broadly instruct the server 225 to perform additional actions related to processing the insurance claim and/or relevant to the claimant is broadly shown comprising the following actions. The server 225 may estimate a repair time for repairing the damage to the property, as shown in 502, may identify one or more repair services capable of repairing the damage to the property, as shown in 504, and/or may determine an availability of repair parts and an availability of repair appointments, as shown in 506, and communicate this information to the claimant or other appropriate person for consideration. If appropriate given the damage to the property, the server 225 may identify one or more salvage services capable of salvaging the damaged property, as shown in 508, and communicate that information to the claimant or other appropriate person. The server 225 may identify one or more settlement options for settling the insurance claim, as shown in 510, and communicate that information to the claimant or other appropriate person. The server 225 may identify a temporary rental or other replacement property for the damaged property, as shown in 512, and communicate that information to the claimant or other appropriate person, such as via wireless communication or data transmission to their mobile device (e.g., smart phone, tablet, laptop, wearable electronics, smart watch, etc.). One or more of these additional actions may be performed substantially automatically and without human interaction.

Further, the executable program may instruct the server 225 to receive or otherwise determine geographic location data for the damaged property or the claimant, as shown in 512, and to consider the geographic location data when performing the one or more additional actions. Even further, the server 225 may use the geographic location data to or otherwise determine the forecasted weather for the geographic location of the damaged property and/or the claimant, as shown in 514, and consider the forecasted weather when performing the one or more additional actions.

The one or more executable programs stored on the non-transitory computer-readable medium may instruct the system to perform more, fewer, or alternative actions, including those discussed elsewhere herein, and particularly those discussed in the section describing the computer-implemented method.

### Exemplary Functionality

The present embodiments may provide for single-photo property damage analysis and propositions. Computer learning technology may be used to analyze a single property damage photo, and make proposals to customers, ranging from estimate creation, repair facility selection or locating suitable repair facilities, or generating or recommending the most suitable repair or settlement option in the event of a vehicle crash.

The present solution may not require any human interaction to provide information to a customer after receiving a single photograph associated with an insurance-related event. The information presented to the customer, such as via their mobile device, may include: (1) a created estimate of damages, such as a detailed description of damages and what may help return the customer to a pre-loss condition; (2) a claim resource location that provides the most up-to-date estimatic services in all areas (including Estimatics, Estimatics Weather, Mobile Service Vendors, Stereo Vendors, Origin and Cause Experts, Salvage Contacts, Salvage Vendors (for vehicle or boats), Marine Surveyors, Wheel and Tire Vendors); (3) a best repair option (in looking at specific details such as geographic location, the types of repairers in the area, and parts and repair time availability, a detailed listing may be provided (such as one that includes data for Cash Settlement, Select Service, Repair Facility, Total Loss Handling, etc.); (4) a rental recommendation (such as based upon related factors, including estimated repair time and availability, a detailed listing of rental providers may be provided); and/or (5) other options that may account for additional model development and those results (examples may include lodging if the loss occurred within the given distance from a customer's home address, disbursements and payments, etc.).

The present embodiments may present customers with the necessary claim handling information with no human to minimal interaction which, in turn, may expedite cycle times relating to receiving an estimate, selecting a repairer if warranted, determining a settlement option, and/or offering other claim handling items, such as rental items.

In one embodiment, a digital photo of a damaged insured asset (e.g., vehicle, home, boat, or other items) may be received at an insurance provider remote server from an insured's mobile device, such as via wireless communication or data transmission. A claims handler module on the remote server may provide certain insurance-related options to the insured (or their mobile device via wireless communication). For instance, a recommended VIS (vehicle inspection site), and/or one or more optional locations for vehicle repair, may be provided to the insured's mobile device based upon the damaged assets location or the GPS location of the insured's mobile device. The best repair or replacement options may be determined from an estimate of damage (from remote server analysis of the digital image of the damaged asset), and presented to the insured via their mobile device. For example, the options may include an estimated time or number of hours to repair the damage, an indication of whether or not the repair vendor or auto body has the required parts to fix the damage in stock (or whether the parts need to be ordered), and other items associated with the repair of the damage. A wireless message may be transmitted to the insured's mobile device (i) asking how the insured would prefer to be paid or re-imbursed under their insurance policy, such as via electronic fund transfer to one of their virtual financial accounts, or electronic transfer directly to the vendor performing the repair work, or (ii) presenting rental vehicle options, such as options determined to be a similar size and model of the damaged vehicle (e.g., sedan or SUV). If the damaged vehicle is greater than 50 miles from the insured's home address (such as determined from analysis of their mobile device's GPS location), a message may be generated and sent to their mobile device asking whether they need temporary lodging, such as a hotel room, while the vehicle is being repaired, and/or an indication of recommended hotels in the area or lodging options.

### Exemplary Insurance-Related Functionality

In one aspect, a computer-implemented method for processing an insurance claim by a claimant for damage to a property, the computer-implemented method comprising: (1) receiving, via one or more processors and/or associated transceivers (such as via wireless communication or data transmission received from a customer's mobile device), digital image data depicting an insured property that has been damaged; (2) comparing, via the one or more processors, the digital image data with a database of images or a trained model of images to classify, or otherwise determine, a level of damage severity for the insured property; (3) estimating, via the one or more processors, an estimated repair or replacement cost for the insured property based upon the level of damage severity determined; (4) generating, via the one or more processors, a proposed insurance claim for the customer based upon the estimated repair or replacement cost; and/or (5) transmitting, via the one or more processors and/or associated transceivers, the (i) estimated repair or replacement cost, and/or (ii) proposed insurance claim (such as via wireless communication or data transmission) to the customer's mobile device to facilitate displaying the (i) estimated repair or replacement cost, and/or (ii) proposed insurance claim on the customer's mobile device for the customer's review, approval, or modification.

The method may further include determining, via the one or more processors, several best options or best vendors available to repair the damaged property based upon (i) vendor availability or estimated time to repair; (ii) repair or replacement part availability at the vendor's location; (iii) customer's reviews of the vendor and/or the vendor's quality of service; and/or (iv) customer mobile device (or damaged property) GPS location and/or vendor GPS location (i.e., proximity of the vendor to the damaged property); and/or transmitting, via the one or more processors and/or associated transceivers (such as via wireless communication or data transmission), the best options or best vendors available to the customer's mobile device for display, and the customer's review and/or selection of an option or a vendor to facilitate repair or replacement of the damaged property.

The method may include determining, via the one or more processors, a single best option or vendor available to repair the damaged property based upon (i) vendor availability or estimated time to repair; (ii) repair or replacement part availability at the vendor's location; (iii) customer's reviews of the vendor and/or the vendor's quality of service; and/or (iv) customer mobile device (or damaged property) GPS location and/or vendor GPS location (i.e., proximity of the vendor to the damaged property); and/or transmitting, via the one or more processors and/or associated transceivers (such as via wireless communication or data transmission), the best option or vendor available to the customer's mobile device for display, and the customer's review and/or selection.

The method may include determining, via the one or more processors, a best rental recommendation to temporarily replace the damaged property based upon (i) vendor availability or estimated time to repair the damaged property; (ii) repair or replacement part availability at the vendor's location; (iii) customer's reviews of the vendor and/or the vendor's quality of service; and/or (iv) customer mobile device or damaged property GPS location and/or vendor GPS location (i.e., proximity of the vendor to the damaged property); and/or transmitting, via the one or more processors and/or associated transceivers (such as via wireless communication or data transmission), the best rental recommendation to the customer's mobile device for display, and the customer's review, approval, and/or selection. The damaged property may be a vehicle, and the rental recommendation may involve a rental vehicle. Alternatively, the damaged property may be a home, and the rental recommendation may involve a hotel room or other temporary lodging. The method may include additional, less, or alternate actions, including those discussed elsewhere herein, and may be implemented via one or more processors and/or transceivers, and/or via computer-executable instructions stored on non-transitory computer-readable media or medium.

In another aspect, a computer system for processing an insurance claim by a claimant for damage to a property may be provided. The computer system may include one or more (local or remote) processors and/or transceivers configured to: (1) receive, via wireless communication or data transmission, digital image data depicting an insured property that has been damaged from a customer's mobile device; (2) compare the digital image data with a database of images or a trained model of images to classify, or otherwise determine, a level of damage severity for the insured property; (3) estimate an estimated repair or replacement cost for the insured property based upon the level of damage severity determined; (4) generate a proposed insurance claim for the customer based upon the estimated repair or replacement cost; and/or (5) transmit the (i) estimated repair or replacement cost, and/or (ii) proposed insurance claim (such as via wireless communication or data transmission) to the customer's mobile device to facilitate displaying the (i) estimated repair or replacement cost, and/or (ii) proposed insurance claim on the customer's mobile device for the customer's review, approval, or modification.

The system and/or the one or more processors/transceivers may be further configured to: determine several best options or best vendors available to repair the damaged property based upon (i) vendor availability or estimated time to repair; (ii) repair or replacement part availability at the vendor's location; (iii) customer's reviews of the vendor and/or the vendor's quality of service; and/or (iv) customer mobile device (or damaged property) GPS location and/or vendor GPS location (i.e., proximity of the vendor to the damaged property); and/or transmit via wireless communication or data transmission the best options or best vendors available to the customer's mobile device for display thereon, and the customer's review and/or selection of an option or a vendor to facilitate repair or replacement of the damaged property.

The one or more processors and/or transceivers may be further configured to: determine a single best option or vendor available to repair the damaged property based upon (i) vendor availability or estimated time to repair; (ii) repair or replacement part availability at the vendor's location; (iii) customer's reviews of the vendor and/or the vendor's quality of service; and/or (iv) customer mobile device (or damaged property) GPS location and/or vendor GPS location (i.e., proximity of the vendor to the damaged property); and/or transmit via wireless communication or data transmission the best option or vendor available to the customer's mobile device for display thereon, and the customer's review and/or selection.

The one or more processors and/or transceivers may be further configured to: determine a best rental recommendation to temporarily replace the damaged property based upon (i) vendor availability or estimated time to repair the damaged property; (ii) repair or replacement part availability at the vendor's location; (iii) customer's reviews of the vendor and/or the vendor's quality of service; and/or (iv) customer mobile device or damaged property GPS location and/or vendor GPS location (i.e., proximity of the vendor to the damaged property); and/or transmit via wireless communication or data transmission the best rental recommendation to the customer's mobile device for display thereon, and the customer's review, approval, and/or selection. The damaged property may be a vehicle, and the rental recommendation may involve a rental vehicle. Alternatively, the damaged property may be a home, and the rental recommendation may involve a hotel room or other temporary lodging. The system may include additional, less, or alternative functionality, including that discussed elsewhere herein.

### Exemplary Repair or Replacement Cost Estimation

In one aspect, a computer-implemented method for generating estimated repair or replacement costs for damaged property may be provided. The computer-implemented method may include (1) receiving, via one or more processors and/or associated transceivers (such as via wireless communication or data transmission received from a customer's mobile device), digital image data depicting an insured property that has been damaged; (2) comparing, via the one or more processors, the digital image data with a database of images (such as images of previously damaged vehicles, boats, homes, or other insured assets with corresponding or previously determined (i) level of damage severity or (ii) actual repair or replacement costs) or a trained model of such images to classify, or otherwise determine, a level of damage severity for the insured property; (3) estimating, via the one or more processors, an estimated repair or replacement cost for the insured property based upon the level of damage severity determined; and/or (4) transmitting, via the one or more processors and/or associated transceivers, the estimated repair or replacement cost (such as via wireless communication or data transmission) to the customer's mobile device to facilitate displaying the estimated repair or replacement cost on the customer's mobile device for the customer's review, approval, or modification.

The method may include generating, via the one or more processors, a proposed insurance claim for the customer based upon the estimated repair or replacement cost; and/or transmitting, via the one or more processors and/or associated transceivers, the proposed insurance claim (such as via wireless communication or data transmission) to the customer's mobile device to facilitate displaying the proposed insurance claim on the customer's mobile device for the customer's review, approval, or modification.

The method may include determining, via the one or more processors, several best options or best vendors available to repair the damaged property based upon (i) vendor availability or estimated time to repair; (ii) repair or replacement part availability at the vendor's location; (iii) customer's reviews of the vendor and/or the vendor's quality of service; and/or (iv) customer mobile device (or damaged property) GPS location and/or vendor GPS location (i.e., proximity of the vendor to the damaged property); and/or transmitting, via the one or more processors and/or associated transceivers (such as via wireless communication or data transmission), the best options or best vendors available to the customer's mobile device for display, and the customer's review and/or selection of an option or a vendor to facilitate repair or replacement of the damaged property.

The method may include determining, via the one or more processors, a best rental recommendation to temporarily replace the damaged property based upon (i) vendor availability or estimated time to repair the damaged property; (ii) repair or replacement part availability at the vendor's location; (iii) customer's reviews of the vendor and/or the vendor's quality of service; and/or (iv) customer mobile device or damaged property GPS location and/or vendor GPS location (i.e., proximity of the vendor to the damaged property); and/or transmitting, via the one or more processors and/or associated transceivers (such as via wireless communication or data transmission), the best rental recommendation to the customer's mobile device for display, and the customer's review, approval, and/or selection. The damaged property may be a vehicle, and the rental recommendation may involve a rental vehicle. Alternatively, the damaged property may be a home, and the rental recommendation may involve a hotel room or other temporary lodging. The method may include additional, less, or alternate actions, including those discussed elsewhere herein, and may be implemented via one or more processors and/or transceivers, and/or via computer-executable instructions stored on non-transitory computer-readable media or medium.

In another aspect, a computer system for generating estimated repair or replacement costs for damaged property may be provided. The computer system including one or more (local or remote) processors and/or transceivers configured to: (1) receive, via wireless communication or data transmission, digital image data depicting an insured property that has been damaged from a customer's mobile device; (2) compare the digital image data with a database of images (such as images of previously damaged vehicles, boats, homes, or other insured assets with corresponding or previously determined (i) level of damage severity, or (ii) actual repair or replacement costs) or a trained model of such images to classify, or otherwise determine, a level of damage severity for the insured property; (3) estimate an estimated repair or replacement cost for the insured property based upon the level of damage severity determined; and/or (4) transmit the estimated repair or replacement cost (such as via wireless communication or data transmission) to the customer's mobile device to facilitate displaying the estimated repair or replacement cost on the customer's mobile device for the customer's review, approval, or modification.

The one or more processors and/or transceivers may be further configured to: generate a proposed insurance claim for the customer based upon the estimated repair or replacement cost; and/or transmit the proposed insurance claim (such as via wireless communication or data transmission) to the customer's mobile device to facilitate displaying the proposed insurance claim on the customer's mobile device for the customer's review, approval, or modification.

The one or more processors and/or transceivers may be further configured to: determine several best options or best vendors available to repair the damaged property based upon (i) vendor availability or estimated time to repair; (ii) repair or replacement part availability at the vendor's location; (iii) customer's reviews of the vendor and/or the vendor's quality of service; and/or (iv) customer mobile device (or damaged property) GPS location and/or vendor GPS location (i.e., proximity of the vendor to the damaged property); and/or transmit via wireless communication or data transmission the best options or best vendors available to the customer's mobile device for display, and the customer's review and/or selection of an option or a vendor to facilitate repair or replacement of the damaged property.

The one or more processors and/or transceivers may be further configured to: determine a best rental recommendation to temporarily replace the damaged property based upon (i) vendor availability or estimated time to repair the damaged property; (ii) repair or replacement part availability at the vendor's location; (iii) customer's reviews of the vendor and/or the vendor's quality of service; and/or (iv) customer mobile device or damaged property GPS location, and/or vendor GPS location (i.e., proximity of the vendor to the damaged property); and/or transmit via wireless communication or data transmission the best rental recommendation to the customer's mobile device for display thereon, and the customer's review, approval, and/or selection. The damaged property may be a vehicle, and the rental recommendation may involve a rental vehicle. Additionally or alternatively, the damaged property may be a home, and the rental recommendation may involve a hotel room or other temporary lodging. The system may include additional, less, or alternate functionality, including that discussed elsewhere herein.

### Exemplary Vehicle or Home Damage Classification Training Flow

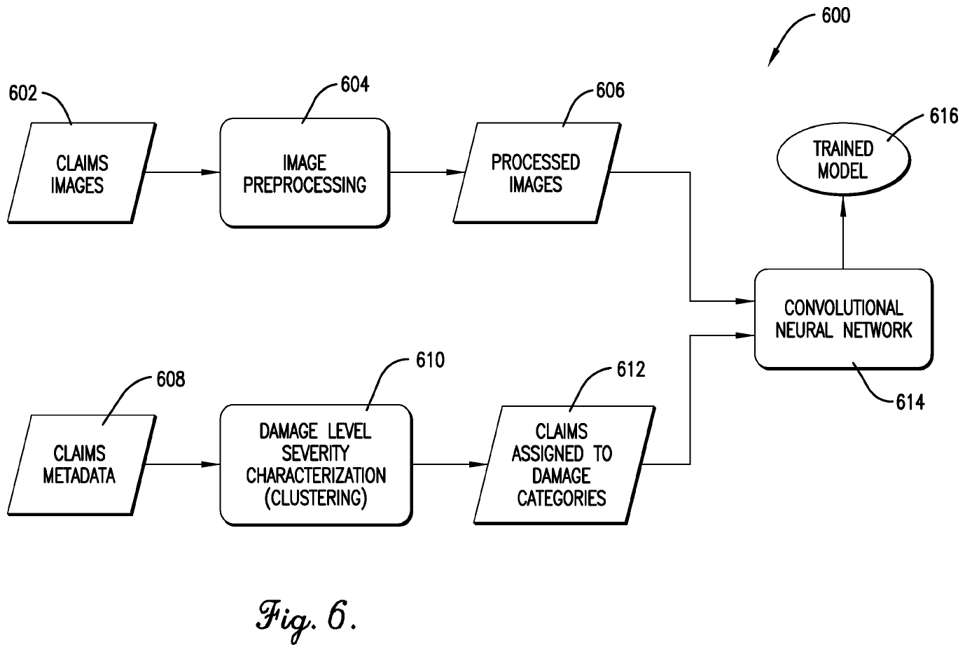

FIG. 6 depicts an exemplary vehicle (or home) damage classification training flow 600. The classification training flow 600 may retrieve or receive claims images 602, such as historical images of vehicles, homes, or other insured assets involved with previous insurance claims. The historical claims images 602 may be retrieved from a database of claims images by one or more processors.

The classification training flow 600 may include image processing 604. For instance, the one or more processors may detect image backgrounds or noise in the claims images 602, and then remove the backgrounds or noise to create processed claim images 606 that leave only, or primarily only, the damaged asset, such as a vehicle, to facilitate more accurate analysis of the extent of damage to the asset.

In some embodiments, metadata may be used to classify vehicle, home, or other insured asset damage level, or level of damage severity. For instance, claims metadata 608 may be analyzed by the one or more processors to determine or estimate a damage level severity or a damage level severity classification 610 (clustering or other techniques may be used). The one or more processors may assign the claims to various damage categories 612.

The processed images 606 and the claims assigned to damage categories 612 may each be used as input to a convolutional neural network (CNN) 614. The CNN 614 may learn to classify vehicles (or homes or other damaged assets) by image to assigned category. After which, the CNN 614 may generate or output a trained model 616. The trained model may be able to classify customer images into various appropriate categories. For instance, the trained model based upon historical claim images may be applied to new images of a recently damaged vehicle (or home, or other insured asset) to determine an estimated level of damage severity, and/or an estimated repair or replacement cost for the damaged vehicle (or home, or other insured asset).

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some exemplary embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some exemplary embodiments, the one or more processors or processor implemented modules may be located in a single geographic location (e.g., within a home environment, an office environment, or a server farm). In other exemplary embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112, sixth paragraph.

The term “insurance policy,” as used herein, generally refers to a contract between an insurer and an insured. In exchange for payments from the insured, the insurer pays for damages to the insured which are caused by covered perils, acts or events as specified by the language of the insurance policy. The payments from the insured are generally referred to as “premiums,” and typically are paid on behalf of the insured upon purchase of the insurance policy or over time at periodic intervals. The amount of the damages payment is generally referred to as a “coverage amount” or a “face amount” of the insurance policy. An insurance policy may remain (or have a status or state of) “in-force” while premium payments are made during the term or length of coverage of the policy as indicated in the policy. An insurance policy may “lapse” (or have a status or state of “lapsed”), for example, when the parameters of the insurance policy have expired, when premium payments are not being paid, when a cash value of a policy falls below an amount specified in the policy (e.g., for variable life or universal life insurance policies), or if the insured or the insurer cancels the policy.

The terms “insurer,” “insuring party,” and “insurance provider” are used interchangeably herein to generally refer to a party or entity (e.g., a business or other organizational entity) that provides insurance products, e.g., by offering and issuing insurance policies. Typically, but not necessarily, an insurance provider may be an insurance company.

Although the embodiments discussed herein relate to property insurance policies, it should be appreciated that an insurance provider may offer or provide one or more different types of insurance policies. Other types of insurance policies may include, for example, homeowners insurance; condominium owner insurance; renter's insurance; life insurance (e.g., whole-life, universal, variable, term); health insurance; disability insurance; long-term care insurance; annuities; business insurance (e.g., property, liability, commercial auto, workers compensation, professional and specialty liability, inland marine and mobile property, surety and fidelity bonds); boat insurance; insurance for catastrophic events such as flood, fire, volcano damage and the like; motorcycle insurance; farm and ranch insurance; personal article insurance; personal liability insurance; personal umbrella insurance; community organization insurance (e.g., for associations, religious organizations, cooperatives); and other types of insurance products. In embodiments as described herein, the insurance providers process claims related to insurance policies that cover one or more properties (e.g., homes, automobiles, personal articles), although processing other insurance policies is also envisioned.

The terms “insured,” “insured party,” “policyholder,” “customer,” “claimant,” and “potential claimant” may be used interchangeably herein to refer to a person, party, or entity (e.g., a business or other organizational entity) that is covered by the insurance policy, e.g., whose insured article or entity (e.g., property, life, health, auto, home, business) is covered by the policy.

Typically, a person or customer (or an agent of the person or customer) of an insurance provider fills out an application for an insurance policy. In some cases, the data for an application may be automatically determined or already associated with a potential customer. The application may undergo underwriting to assess the eligibility of the party and/or desired insured article or entity to be covered by the insurance policy, and, in some cases, to determine any specific terms or conditions that are to be associated with the insurance policy, e.g., amount of the premium, riders or exclusions, waivers, and the like. Upon approval by underwriting, acceptance of the applicant to the terms or conditions, and payment of the initial premium, the insurance policy may be in-force, (i.e., the policyholder is enrolled).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

1-20. (canceled)

21. A computer-implemented method for improving the functionality of a computer for assessing damage to a property, the computer-implemented method comprising:
generating, by a processor, a set of image models based on images of a plurality of properties using a machine learning technique prior to assessing damage to the property, each image model of the image models being associated with a property type;
storing in a memory the set of image models;
receiving, by the processor, image data depicting the damage to the property;
identifying, by the processor, at least one characteristic associated with the property in the image data using the set of image models;
determining, by the processor, a type of the property depicted in the image data based upon the at least one identified characteristic;
selecting, by the processor and from the memory, an image model from the set of image models based upon the type of the property;
determining, by the processor, an amount of damage to the property as indicated in the image data by analyzing the image data using the selected image model; and
initiating one or more actions related to the damage to the property.

22. The computer-implemented method as set forth in claim 21, wherein the property is a vehicle.

23. The computer-implemented method as set forth in claim 21, wherein the property is a structure.

24. The computer-implemented method as set forth in claim 21, wherein the image data consists of a single image of the vehicle.

25. The computer-implemented method as set forth in claim 21, wherein the image data includes one or more still images of the vehicle.

26. The computer-implemented method as set forth in claim 21, wherein the image data includes one or more moving images of the vehicle.

27. The computer-implemented method as set forth in claim 21, wherein the one or more actions are performed substantially automatically and without human interaction.

28. The computer-implemented method as set forth in claim 21, wherein the one or more actions include estimating a repair cost for repairing the damage to the property, or a replacement cost for the property.

29. The computer-implemented method as set forth in claim 21, wherein the one or more actions include estimating a repair time for repairing the damage to the property.

30. The computer-implemented method as set forth in claim 21, wherein the one or more actions include identifying one or more repair services capable of repairing the damage to the property.

31. The computer-implemented method as set forth in claim 30, wherein the one or more actions include determining an availability of repair parts and an availability of repair appointments.

32. The computer-implemented method as set forth in claim 31, wherein the one or more actions include identifying one or more salvage services capable of salvaging the damaged property based upon, at least in part, a GPS location of the damaged property.

33. The computer-implemented method as set forth in claim 21, wherein the one or more actions include identifying a temporary replacement property for the damaged property.

34. The computer-implemented method as set forth in claim 21, further including receiving geographic location data for the damaged property, and considering the geographic location data when performing at least one of the one or more actions.

35. The computer-implemented method as set forth in claim 34, further including using the geographic location data to determine a forecasted weather for the geographic location, and considering the forecasted weather when performing at least one of the one or more actions.

36. The computer-implemented method as set forth in claim 21, further including receiving and analyzing audio data according to an audio model in the same manner as the image data.

37. A computer-implemented method for improving the functionality of a computer for assessing damage to a property, wherein the property is a vehicle or a structure, the computer-implemented method comprising:
generating, by a processor, a set of image models based on images of a plurality of properties using a machine learning technique prior to assessing damage to the property, each image model of the image models being associated with a property type;
storing in a memory the set of image models;
receiving, by the processor, image data depicting the damage to the property;
identifying, by the processor, at least one characteristic associated with the property in the image data using the set of image models;
determining, by the processor, a type of the property depicted in the image data based upon the at least one identified characteristic;
selecting, by the processor and from the memory, an image model from the set of image models based upon the type of the property;
determining, by the processor, an amount of damage to the property as indicated in the image data by analyzing the image data using the selected image model;
determining a repair cost for the property based upon the amount of damage to the property;
receiving geographic location data for the property; and
performing, by the processor substantially automatically and without human interaction, one or more additional actions selected from the group consisting of: estimating a repair time for repairing the damage to the property, identifying one or more repair services capable of repairing the damage to the property, determining an availability of repair parts and an availability of repair appointments, identifying one or more salvage services capable of salvaging the property, and identifying a temporary replacement property for the property, wherein in performing at least one of the one or more additional actions the processor considers the geographic location data for the property.

38. The computer-implemented method as set forth in claim 37, wherein the image data consists of a single image of the vehicle.

39. A system for assessing damage to a property, wherein the property is a vehicle or a structure, the system comprising:
a memory storing a set of image models; and
a processor configured to:
generate the set of image models based on images of a plurality of properties using a deep learning technique prior to assessing damage to the property, each image model of the image models being associated with a property type;
receive image data depicting the damage to the property,
identify at least one characteristic associated with the property in the image data using the set of image models;
determine a type of the property depicted in the image data based upon the at least one identified characteristic,
select an image model from the set of image models stored in the memory based upon the type of the property,
determine an amount of damage to the property as indicated in the image data by analyzing the image data according to the image model, and
perform one or more additional actions related to the damage to the property.
